(19) United States
(12) Patent Application Publication
(10) Pub. No.: US 2022/0198277 A1
(43) Pub. Date: Jun. 23, 2022

(54) POST-HOC EXPLANATION OF MACHINE LEARNING MODELS USING GENERATIVE ADVERSARIAL NETWORKS

(71) Applicant: Oracle International Corporation, Redwood Shores, CA (US)

(72) Inventors: Karoon Rashedi Nia, Vancouver (CA); Tayler Hetherington, Vancouver (CA); Zahra Zohrevand, Vancouver (CA); Yasha Pushak, Vancouver (CA); Sanjay Jinturkar, Santa Clara, CA (US); Nipun Agarwal, Saratoga, CA (US)

(21) Appl. No.: 17/131,387

(22) Filed: Dec. 22, 2020

(51) Int. Cl. G06N 3/08; G06N 3/04

(52) U.S. Cl. CPC G06N 3/088; G06N 3/0454

(57) ABSTRACT

Herein are generative adversarial networks to ensure realistic local samples and surrogate models to provide machine learning (ML) explainability (MLX). Based on many features, an embodiment trains an ML model. The ML model inferences an original inference for original feature values respectively for many features. Based on the same features, a generator model is trained to generate realistic local samples that are distinct combinations of feature values for the features. A surrogate model is trained based on the generator model and based on the original inference by the ML model and/or the original feature values that the original inference is based on. Based on the surrogate model, the ML model is explained. The local samples may be weighted based on semantic similarity to the original feature values, which may facilitate training the surrogate model and/or ranking the relative importance of the features. Local sample weighting may be based on populating a random forest with the local samples.

### RELATED CASE

Incorporated herein in its entirety is related U.S. patent application Ser. No. 17/124,018 titled USING GENERATIVE ADVERSARIAL NETWORKS TO CONSTRUCT REALISTIC COUNTERFACTUAL EXPLANATIONS FOR MACHINE LEARNING MODELS filed on Dec. 16, 2020 by Karoon Nia et al.

### FIELD OF THE INVENTION

The present invention relates to local explanations of machine learning (ML) inferencing. Herein are generative adversarial networks (GANs) to ensure realistic local samples and surrogate models to provide ML explainability (MLX).

### BACKGROUND

Machine learning and deep learning are becoming ubiquitous for two main reasons: their ability to solve complex problems in a variety of different domains and the growth in the performance and efficiency of modern computing resources to support these kinds of algorithms. However, as the complexity of problems continues to increase, so too does the complexity of the machine learning models applied to those problems.

Deep learning is a prime example of this complexity trend. Some machine learning algorithms, such as neural networks, may only contain a few layers of densely connected neurons, whereas deep learning algorithms, such as convolutional neural networks, may contain tens to hundreds of layers of neurons performing vastly different operations. Increasing the depth of the model and heterogeneity of layers provides many benefits. For example, going deeper can increase the capacity of the model, improve the generalization of the model, and provide opportunities for the model to filter out unimportant features. Likewise, including layers that perform different operations can greatly improve the performance of the model. However, these optimizations come at the cost of increased complexity and reduced interpretability such as according to human understanding. Explaining and interpreting the results from complex deep learning models is a challenging task compared to many other machine learning models.

Understanding the importance of features and how they contribute to a model's prediction may be straightforward for a limited few model architectures that naturally provide at least some visibility into inferencing. For example, the larger a feature's learned weight, the larger the impact that feature has on the output of the model. As another example, consider a classification decision tree with multiple input features. During training, the features that have the largest impact on the class predictions are inserted near the root of the tree, while the features that have less impact on class predictions fall near the leaves of the tree. The feature importance can be determined by evaluating: a) the distance of a decision node (corresponding to a feature and value that maximizes the class split at this node) to the root of the tree and b) the ability for this feature to split the class space (impurity).

Such models are often referred to as being inherently interpretable. However, as the complexity of the model increases (e.g., the number of features or depth of the decision tree increases), it becomes increasingly challenging to interpret the explanation. Similarly, even relatively simple neural networks with a few layers can be challenging to interpret, as multiple layers combine the effects of features and increase the number of operations between the model inputs and outputs. Consequently, there is a requirement for alternative techniques to aid with the interpretation of complex machine learning and deep learning models.

### BRIEF DESCRIPTION OF THE DRAWINGS

In the drawings:

FIG. 1 is a block diagram that depicts an example computer that creates and uses a first machine learning (ML) model such as a surrogate model to provide local explanations of an inference such as the label of original feature values that was inferred by a second ML model such as a classifier model;

FIG. 2 is a flow diagram that depicts an example computer process that creates and uses a surrogate model to provide local explanations of the label of original feature values that was inferred by a classifier model;

FIG. 3 is a flow diagram that depicts an example computer process for training a surrogate model;

FIG. 4 is a flow diagram that depicts an example computer process for assigning respective weights to local samples;

FIG. 5 is a flow diagram that depicts an example computer process for initializing and optimizing noise;

FIG. 6 is a flow diagram that depicts example training activities;

FIG. 7 is a flow diagram that depicts example ML explainability (MLX) activities that may occur during an MLX invocation;

FIG. 8 is a flow diagram that demonstrates reusability of an already-trained generator model;

FIG. 9 is a block diagram that depicts an example computer that uses a surrogate model to provide optimized explanations of a black-box model;

FIG. 10 is a block diagram that illustrates a computer system upon which an embodiment of the invention may be implemented;

FIG. 11 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein are local machine learning (ML) explainability (MLX) techniques that faithfully explain any ML classifier or regressor such as for tabular datasets. An interpretable surrogate ML model is used to explain the behavior of a complex black-box ML model on a generated local neighborhood of local sample samples. For evaluating the black-box model and training the surrogate explainer model, a generator ML model of a Generative Adversarial Network (GAN) is trained and used to generate a realistic local sample neighborhood according to the characteristics of the dataset that the black-box model was trained on. In an embodiment, training the surrogate model leverages a supervised neighborhood analysis approach to achieve high explanation fidelity when generating explanations for specific predictions from the black-box model.

Data distribution is crucial for realism. Local sample examples need to be generated according to the training data distribution. That is, the local samples should be realistic. Perturbing the instance-to-explain to generate the local sample instances may lead to out-of-distribution samples. For example, when modifying the feature values, a 600 square-foot house may have the value for its number of rooms perturbed to ten, which is unrealistic. Unrealistic data is problematic because it may confuse the black-box ML model, which decreases accuracy of inferencing such as classification. In other words, unrealistic local samples occur in regions of a multidimensional problem space where the black-box ML model is unreliable or even unstable such as prone to unpredictable discontinuities in the prediction solution space that prevent a local sample from being modified or used as-is in the real world as predicted. Thus, unrealistic local samples have little explanatory value and may undermine confidence in MLX.

Important MLX use cases are interactive and do not tolerate latency well. Customer experience (CX) may be at stake. For example, MLX may be used during a phone conversation such as with a support or sales agent. Local sample samples should be generated in a reasonable time. Optimizing the above concerns and criteria is expensive with high dimensional datasets having many constituent datatypes.

GAN-based approaches herein are well suited for these technical challenges as follows. GANs herein excel at generating realistic synthetic data. Unlike other local sample methods, which may result in data samples that are highly unlikely to occur in real data, correct behavior of the black-box ML model can be studied on realistic samples where the black-box ML model's output is presumed valid.

Herein are ways to optimize a generator model to generate samples which are strictly local to the instance-to-explain. Other GAN approaches generate data samples that cover the whole data space (global). However, local explanation models need to synthesize data in the local neighborhood of the instance-to-explain. Herein are ways to constrain a generator model to generate samples that are local to the instance-to-explain by optimizing a latent random variable.

The generator model takes as input random noise and transforms it into realistic synthetic samples which may contain any combination of numerical and categorical features. Approaches herein guide the random input noise toward generating samples that are close in proximity/similarity to the instance-to-explain by optimizing a custom loss function and backpropagating gradients with respect to the input noise. The changes to the feature values are caused by changes in the random input noise that is driven by the gradients' magnitude and direction. Thus, this approach can handle both numerical and categorical features seamlessly while synthesizing samples following the true data distribution.

Techniques herein provides several advantages over other solutions as follows. Feature distributions and correlations are well approximated. To study the black-box model's behavior around the instance of interest, local sample samples need to be generated within the local region around the instance by assigning values to each feature. If the generated samples differ significantly from those used to train the black-box model, the explanation may not be representative of the local behavior of the black-box model as observed in practice. For example, the black-box ML model output may not be valid for unexpected, improbable, or impossible combinations of input feature values. Consequently, the explanation may be misleading and/or focus on parts of the black-box ML model's behavior that will likely never occur under normal operation. Techniques herein ensure that the generated local sample instances follow similar feature distributions and correlations from the training data used to train the black-box model.

Interactivity demands online runtime performance, including liveliness of generating local samples for a certain instance. Once the generator model has been trained, it can be optimized to generate local sample instances for different original samples with low latency. Offline GAN training on a given dataset may be slower than other techniques depending on the complexity of the black-box ML model and size of the dataset. However, training only needs to be done once per dataset, and the cost of training is subsequently amortized over many MLX invocations at runtime. That is, the trained generator model is reusable and fast.

Herein are kinds of explainers based on a separate, inherently interpretable surrogate model (such as a linear model or decision tree) to explain the local behavior of a black-box model. Locality here is defined relative to the instance (sample) being explained. In such explainers, the interpretable surrogate model is used to approximate the local behavior of the black-box model. If the surrogate model accurately approximates the local behavior of the complex black-box model, the feature importance from the surrogate model can be used to estimate the feature importance of the original black-box model for the specific sample. The resulting explanation consists of the relative feature importance order and weights indicating the level of relative importance. The key insight from these explainers is that while the global black-box model behavior may be far too complex to approximate with a simple interpretable model, the local behavior of the black-box model may be much easier to approximate.

Fidelity of the surrogate model as a proxy for the black-box model is crucial. A major goal of surrogate-model local explanation techniques herein is to closely approximate the local behavior of the trained black-box model. Although it may be difficult to interpret the global behavior of a complex black-box ML model, it may be feasible to explain the block-box model locally by optimizing the fidelity of the surrogate model responses to the corresponding black-box model predictions for a limited neighborhood of local samples. The intuition here is that if an interpretable surrogate model can closely approximate the local behavior of a complex black-box model, the interpretation of the surrogate model can be used to approximate the reasoning behind the complex black-box model's decision. Additionally, the explanation for the same instance-to-explain should be repeatable. Along with making use of a GAN to generate local samples within local neighborhoods, techniques herein leverage a supervised neighborhood analysis approach to improve the weighting of generated local samples relative to the local instance being explained. Recent experiments confirm that the combination of these techniques significantly increases the fidelity of the surrogate model to the black-box model.

Based on many features, an embodiment trains an ML model. The ML model inferences an original inference for original feature values respectively for the features. Based on the same features, a generator model is trained to generate realistic local samples that are distinct combinations of feature values for the features. A surrogate model is trained based on the generator model and also based on the original inference by the ML model and/or the original feature values that the original inference is based on. Based on the surrogate model, the ML model is explained.

In an embodiment, the local samples are weighted based on semantic similarity to the original feature values, which may facilitate training the surrogate model and/or ranking the relative importance of the features. In an embodiment, local sample weighting is based on populating a random forest with the local samples. In any case, the cost of training the reusable generator model may be amortized across many MLX invocations.

### 1.0 Example Computer

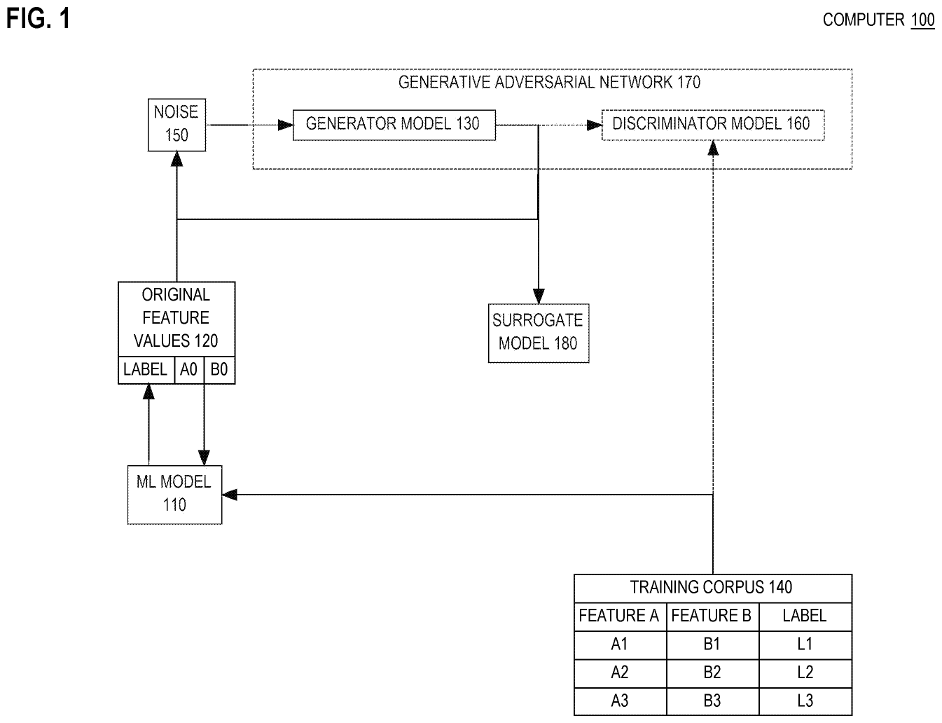

FIG. 1 is a block diagram that depicts an example computer 100, in an embodiment. Computer 100 creates and uses a first machine learning (ML) model such as surrogate model 180 to provide local explanations of an inference such as the label of original feature values 120 that was inferred by a second ML model such as ML model 110. Computer 100 uses: a) a third ML model such as discriminator model 160 to train a fourth ML model such as generator model 130 to generate realistic local samples (not shown) that are similar to original feature values 120 and b) a latent space such as noise 150 to optimize perturbations of features A-B. Computer 100 may be one or more of a rack server such as a blade, a personal computer, a mainframe, a virtual computer, a smartphone, or other computing device.

Computer 100 or another computer presently or historically hosts and operates already-trained ML model 110 to generate a label or other inference from original feature values 120. In an embodiment, original feature values 120 is a feature vector that contains values A0-B0 for respective features A-B of a complex data item (not shown). In an embodiment, the data item is a table row in a database, and values A0-B0 are copies, derivations, or encodings of values of respective fields of the table row. In an embodiment, features A-B correspond to respective columns of the table in the database.

### 1.1 Black-Box Model

In an embodiment, the inference generated by ML model 110 is the label of original feature values 120. In an embodiment, the inference generated by ML model 110 is instead a score such as a probability and/or an anomaly score such as for anomaly detection. In an embodiment, the inference generated by ML model 110 is instead a set of probabilities for each of many mutually exclusive possible labels. In an embodiment, ML model 110 is not a classifier but instead has another inferential role such as regression, anomaly detection, or prediction.

Original feature values 120 and the inference generated by ML model 110 from original feature values 120 are stored for review. In various scenarios, original feature values 120 and its inferred label are reviewed for various reasons. In one scenario, computer 100 generates an explanation of why ML model 110 inferred that label for original feature values 120 such as for machine learning explainability (MLX).

For example, the explanation may be needed for regulatory compliance. Likewise, the explanation may reveal an edge case that causes ML model 110 to malfunction for which retraining with different data is needed. In another scenario, computer 100 generates suggested other feature values that are similar to original feature values 120 but that may cause ML model 110 to make a same or different inference.

A technical problem for such MLX is that ML model 110 may be a black-box model that has an unknown or opaque architecture that more or less precludes direct inspection and interpretation of the internal operation of ML model 110. For example if the ML model 110 has an unknown architecture, computer 100 may be more or less unable to explain why ML model 110 inferred the label of original feature values 120 nor which minor changes to original feature values 120 would cause a different label.

### 1.2 Surrogate Model

That technical problem is solved with surrogate model 180 that should not be a black-box model. Even though models 110 and 180 should have different architectures (i.e. different ML algorithms and/or different hyperparameter configurations), models 110 and 180 are functionally similar. For example, models 110 and 180 may be trained with different respective training corpuses that have same features A-B and may learn to make similar inferences for same values of features A-B. Likewise, models 110 and 180 may be trained with different training corpuses that have similar value distributions for same features A-B.

Unlike ML model 110, surrogate model 180 has a transparent architecture that computer 100 can inspect, analyze, and understand. That is, computer 100 knows why surrogate model 180 makes various inferences based on various values of features A-B. Example architectures for surrogate model 180 are discussed later herein.

Because surrogate model 180 is functionally similar to ML model 110, surrogate model 180 may be used as a proxy for ML model 110 in some ways. Thus, an explanation of why surrogate model 180 infers a label for an input is also an explanation of why ML model 110 would infer the same label for the same input. In other words, MLX for surrogate model 180 may be used as MLX for ML model 110.

### 1.3 Local Sample

In any case, generated explanations and suggestions are based on local sample data that may be more or less similar to original feature values 120. Generator model 130 generates local samples that are not expected to be historical data and may contain combinations of values for features A-B that never before occurred. Ideally, local samples generated by generator model 130 should be similar to original feature values 120 but different enough to cause ML model 110 to provide a same or different label or other inference as the label of original feature values 120.

Although local samples should be more or less similar to original feature values 120, the local samples may be generated without using original feature values 120 as a starting point. For example, generator model 130 may generate a sequence of local samples that starts with a first local sample that may be generated without referencing original feature values 120. After generator model 130 is trained, that first local sample is generated by generator model 130 that is applied to noise 150 as sole input.

### 1.4 Training

In an embodiment: a) ML model 110 is already trained, b) ML model 110 already inferred the label of original feature values 120, and c) GAN models 130 and 160 are not trained until MLX is later needed for original feature values 120 and ML model 110. In any case: a) training of discriminator model 160 is supervised, and b) surrogate model 180 is trained last based on local samples generated by generator model 130 after training of generator model 130.

Generator model 130 may be an ML model that is trained to generate realistic synthetic samples such as those shown in the respective rows of training corpus 140. Noise 150 may have different values, as discussed later herein, that cause generator model 130 to generate different respective synthetic samples. Computer 100 creates, hosts, trains, deploys, and operates generator model 130 as follows.

In an embodiment, generator model 130 is trained while part of generative adversarial network (GAN) 170 that contains two competing models 130 and 160 such as ML models that cooperatively train as follows. In training, generator model 130 learns to generate realistic synthetic samples, and discriminator model 160 learns to detect whether a given combination of values for features A-B is a natural combination in training corpus 140 or instead a synthetic sample combination that generator model 130 generated.

For example such as for backpropagation in an artificial neural network (ANN), training error of discriminator model 160 may be based on: a) accurate binary or probabilistic classification (i.e. detection) of a combination of feature values as real or synthetic sample, and/or b) reconstruction error such as when discriminator model 160 is configured to learn how to regenerate the combination of feature values that was input such as when discriminator model 160 is an autoencoder. Likewise, training error of generator model 130 may be based on: a) by discriminator model 160, incorrect binary or probabilistic classification of a combination of feature values as real or synthetic sample, and/or b) reconstruction error such as when generator model 130 is configured to learn how to regenerate noise 150 that was input such as when generator model 130 is an autoencoder. Techniques for training GAN models 130 and 160 are presented in related U.S. patent application Ser. No. 17/124,018.

### 1.5 Runtime

Although generator model 130 may train as part of GAN 170, generator model 130 may be deployed with or without GAN 170 after training. For example, GAN 170 and discriminator model 160 are shown with dashed lines to indicate that they may or may not be present in computer 100 after generator model 130 is deployed into service. Although generating local samples is the only contribution of generator model 130 in production operation, computer 100 may process and react in various ways to each local sample in a sequence of local samples generated by generator model 130. Indeed, there may be a feedback loop in which computer 100 numerically analyzes a current local sample (not shown) to cause a quantitative adjustment to noise 150 such that the sequence of local samples generated by generator model 130 evolves as follows.

In production operation, the current local sample generated by generator model 130 is analyzed in two ways. First, ML model 110 is applied to the current local sample to generate a current inference. Second and as explained later herein, a difference or distance of feature values between the current local sample and original feature values 120 is measured as a current distance.

### 1.6 Optimization

As discussed later herein, the current distance may be formulaically integrated to measure the explanatory capacity of the current local sample. That measurement may be used to judge the fitness of noise 150 as a stimulus that causes generator model 130 to generate local samples that should be convincingly realistic, somewhat similar to original feature values 120, and meaningful for explanation such that the current label and the label of original feature values 120 sometimes are identical and sometimes differ. Thus as explained later herein, quantitative analysis of a current local sample may be used to optimize noise 150 to cause generator model 130 to generate increasingly interesting local samples that are relevant to explaining why ML model 110 inferred a particular label or score for original feature values 120.

Because noise 150 is incrementally improved after each current local sample, a sequence of respective distances may be more or less monotonically decreasing as generator model 130 generates local samples that are increasingly similar to original feature values 120. Techniques for noise optimization are presented in related U.S. patent application Ser. No. 17/124,018.

### 2.0 Machine Learning Explainability (MLX) Lifecycle

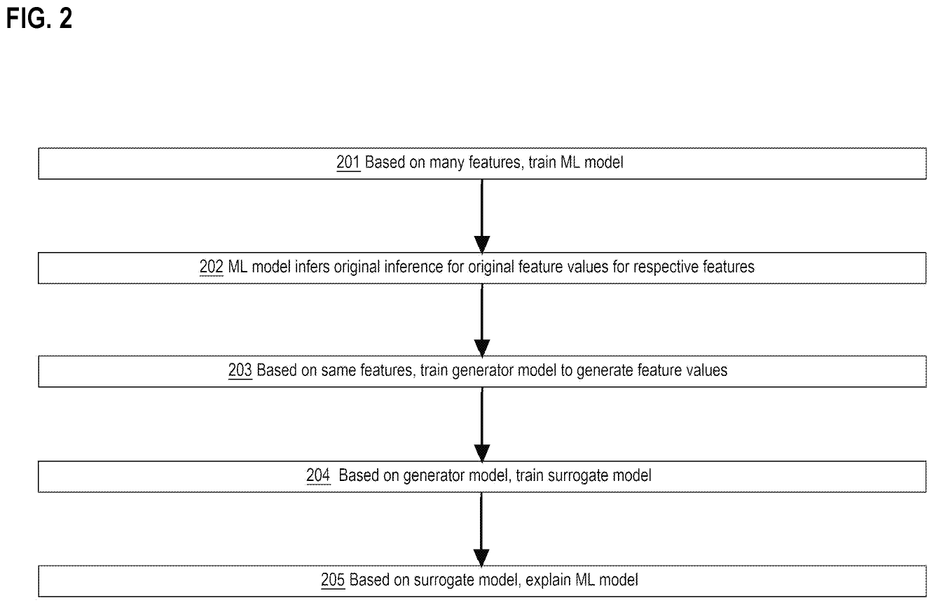

FIG. 2 is a flow diagram that depicts an example process that an embodiment of computer 100 may perform to create and use surrogate model 180 to provide local explanations of an inference such as the label of original feature values 120 that was inferred by ML model 110. FIG. 2 is discussed with reference to FIG. 1.

In an embodiment, computer 100 resides in a production environment. Steps 201-202 are preparatory, precede an MLX use case, and may or may not occur in the production environment. Based on training corpus 140, computer 100 or a second computer in a development environment performs step 201 that trains ML model 110. In an embodiment, ML model 110 is already trained and step 201 is absent.

Training by step 201 may be supervised or not in various embodiments. Labels L1-L3 may preexist step 201 or step 201 may infer labels L1-L3 in various embodiments. Training corpus 140 may or may not contain original feature values 120.

Computer 100 or the second computer or a third computer in a same or different production environment as computer 100 performs step 202. For example, computer 100 may be in an MLX production environment such as for customer support, and the third computer may be in a transactional production environment such as for online transaction processing (OLTP). In step 202, ML model 110 infers an original label or other inference for original feature values 120 for respective features A-B.

MLX may occur anytime after step 202 and entails computer 100 performing steps 203-205 as follows. That is, any MLX use case may entail steps 203-205. Based on same training corpus 140, step 203 trains generator model 130 to generate local sample feature values for features A-B. Training model 130 may entail cooperatively training discriminator model 160.

As explained later herein, step 203: a) trains discriminator model 160 based on same training corpus 140 or a similar training corpus having same features A-B and generator model 130, and b) concurrently trains generator model 130 based on discriminator model 160 and noise 150 that is randomly generated and unchanging during step 203. Because generator model 130 is trained based on discriminator model 160, if discriminator model 160 is trained based on training corpus 140, generator model 130 is effectively trained indirectly based on training corpus 140. Techniques for training GAN models 130 and 160 are presented in related U.S. patent application Ser. No. 17/124,018.

Although not shown between steps 203-204, generator model 130 generates a sequence of local samples that are more or less similar to original feature values 120 as discussed later herein. In various embodiments, discriminator model 160 is retained or discarded immediately after step 203. For example, discriminator model 160 may be retained and used as a filter that decides which local samples are realistic enough to include in that sequence and which local samples should be immediately discarded as unrealistic.

In various embodiments, generator model 130 is retained or discarded after generating that sequence of local samples. For example, that sequence of local samples evolves toward original feature values 120 as a target as discussed later herein but, because step 203 generally trained generator model 130 independent of original feature values 120, generator model 130 may be retained for future reuse in another MLX invocation with different values of features A-B as a different explanation target.

Reusable generator model 130 generates a different sequence of local samples for each MLX invocation. That is, subsequent MLX invocations may skip step 203 because reusable generator model 130 needs training only once. In that way, the cost of step 203 may be amortized across many MLX invocations. However if training corpus 140 is revised or replaced, steps 201-203 should be repeated.

Based on generator model 130 or more specifically, based on those local samples generated by generator model 130, step 204 trains surrogate model 180. In most embodiments, step 204 entails supervised training, as discussed later herein. Although step 203 generates a sequence of local samples, the ordering of the sequence need not be preserved for step 204. For example, the sequence may be reordered to maximize human interpretability of surrogate model 180 such as according to information gain, impurity, and/or entropy such as when surrogate model 180 is a decision tree.

Although step 204 and possibly step 203 occur during an MLX invocation, steps 203-204 are preparatory for MLX. MLX itself occurs in step 205. Based on surrogate model 180, step 205 explains ML model 110 in various ways for various MLX use cases. In one use case, step 205 explains why ML model 110 inferred the label of original feature values 120. For example, step 205 may identify which of features A-B were determinative. In another use case, step 205 suggests minimal changes to a few of feature values A0-B0 that would instead cause ML model 110 to infer a different label. Those and additional MLX scenarios are discussed later herein.

Generally, MLX explanations may indicate which features A-B direct the inferencing by ML model 110, which may also entail indicating particular feature values and/or particular inferences. Generally, MLX explanations may additionally or instead indicate which parameters of ML model 110 direct the inferencing by ML model 110. For example if ML model 110 is a mathematical regression, then an MLX explanation may indicate which parameters such as which regression coefficients direct the inferencing.

### 3.0 Surrogate Model Training

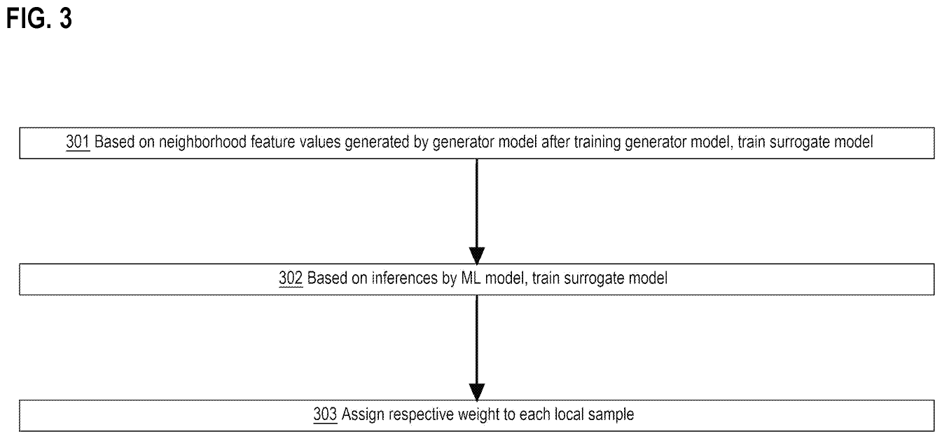

FIG. 3 is a flow diagram that depicts an example process for training surrogate model 180. FIG. 3 is discussed with reference to FIG. 1.

Steps 301-303 show various activities that various embodiments may or may not use to train surrogate model 180. Some or all of steps 301-303 may occur and/or be combined into a same step. In other words, surrogate model 180 is trained only once, no matter how many of training steps 301-303 are involved.

As discussed earlier herein, generator model 130 generates a sequence of local samples for training surrogate model 180. Because that sequence evolves within a multidimensional feature space neighborhood that is around original feature values 120, that generated sequence of local samples is known herein as neighborhood local samples. Based on neighborhood feature values generated by generator model 130 after training generator model 130, step 301 trains surrogate model 180.

Training of surrogate model 180 is based on models 110 and 130. One goal of generating neighborhood local samples by generator model 130 is to discover classification boundaries within the multidimensional space of features A-B. A classification boundary separates combinations of feature values based on their respective labels such that the boundary is crossed by slightly modifying values of feature(s) in a way that changes the inferred label.

However, generator model 130 generates unlabeled local samples. Thus, the unlabeled local samples should be submitted to ML model 110 for labeling. Based on inferences such as labels by ML model 110, step 302 trains surrogate model 180.

Respective relative importance of each local sample may be incorporated into or otherwise used for an MLX explanation and/or surrogate model 180 as explained later herein. Respective weights may quantify relative local sample importance. Step 303 assigns a respective weight to each local sample. Local sample weight measurement and use are discussed later herein.

The ordering of steps 302-303 depends on the embodiment. In various embodiments explained later herein, surrogate training step 302 occurs after local sample weighting step 303 such that surrogate training depends on local sample weights.

### 4.0 Weighting Local Samples

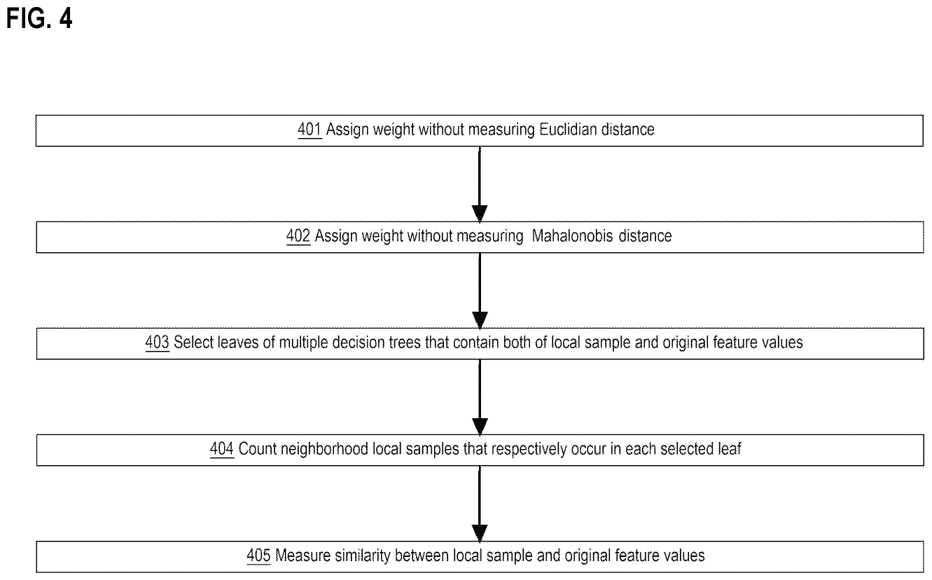

FIG. 4 is a flow diagram that depicts an example process for assigning respective weights to local samples. FIG. 4 is discussed with reference to FIG. 1.

The weight of a local sample may depend on how similar is the local sample to original feature values 120. Other techniques may measure similarity based on Euclidian distance within a multidimensional feature space between the local sample and original feature values 120. In some embodiments, a problem with Euclidian distance is that differences in respective scales of features A-B may distort similarity.

For example, feature A may be a manufacture year and feature B may be a price. A difference between years 2010 and 2020 is ten. Whereas a difference between $30,000 and $30,100 is a hundred, which is an order of magnitude bigger distance component of a multidimensional distance.

Thus for comparing cars of a same make and model, cars made in a same year but differing in price by $100 would be measured as being more different than cars of a same make and model and price made in different decades, which may be very misleading. Somewhat less misleading may be measuring Euclidian distance components as percentages such as a percent difference between two prices. Step 401 assigns weight without measuring Euclidian distance.

If the Euclidian distance is not based on natural units of features A-B but instead based on statistical units such as standard deviation, then the distance is a Mahalonobis distance that may somewhat increase the relevance of feature distance measurement. However, Mahalonobis distance only works when most or all of features A-B have statistically normal distributions, which is unlikely. Step 402 assigns weight without measuring Mahalonobis distance.

Similarity distance measurement herein for weighting of local samples uses a forest of multiple decision trees to tolerate various value range distortions such as skew and discontinuity. The forest facilitates distance measurement that accommodates natural semantics of features A-B. For example, an American football team score of six or seven points is common, but scores of five or eight points are rare due to game semantics.

Steps 403-405 measure similarity distance based on multiple decision trees such as a random forest as follows. A random forest or random decision forest is an ensemble learning approach that constructs a collection of randomly generated tree nodes and decision trees during a training phase of the random forest. Different decision trees of a forest are constructed to be each randomly restricted to only particular subsets of features A-B, such as with feature bootstrap aggregating (bagging). The decision trees gain accuracy as the decision trees grow without being forced to over fit training data as would happen if a decision tree were forced to learn all features A-B.

The random forest is populated in a typical way with original feature values 120 for the MLX invocation. However afterwards, the random forest is used in an extraordinary way as follows. Only the leaves of the trees of the random forest are used, and the other nodes in the multiple trees are ignored after the random forest is populated (i.e. trained). In other words after training, the trees are not operated in the usual tree traversal way as decision trees but instead are specially operated as follows to facilitate semantic distance measurement between a local sample and original feature values 120.

Step 403 selects leaves of the multiple decision trees that contain both the local sample and original feature values 120. Step 404 counts neighborhood local samples that respectively occur in each leaf selected by step 403. Step 405 measures similarity between the local sample and original feature values 120.

In an embodiment, similarity measurement by step 405 depends on results of steps 403-404 as follows. In an embodiment, step 405 initializes the weight of the local sample being weighed to zero. In an embodiment, for each leaf selected by step 403, that weight is increased by step 405 by the inverse of the count by step 404 of local samples in that leaf. For example if that leaf contains four local samples, then 0.25 is added to the weight of the local sample being weighed. In other words in an embodiment, step 405 weighs by summation of various fractions. After weighing each neighborhood local sample, the weights may be used in various ways as explained later herein.

### 5.0 Noise Optimization

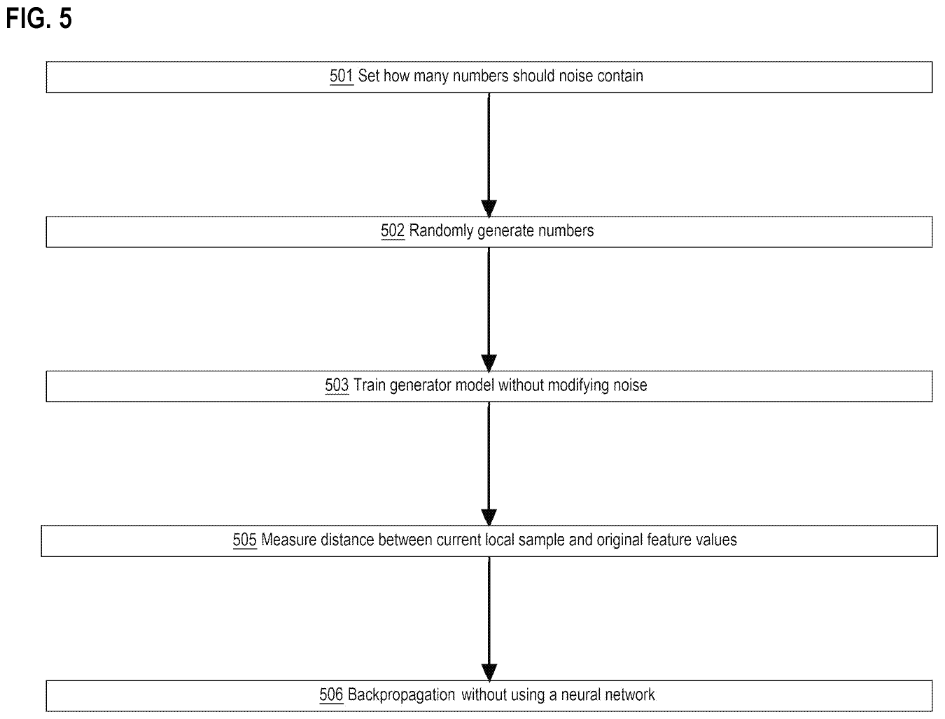

FIG. 5 is a flow diagram that depicts an example process for initializing and optimizing noise. FIG. 5 is discussed with reference to FIG. 1.

As explained earlier herein, causing generator model 130 to generate a progressively improving sequence of local samples entails incrementally optimizing noise 150 after each local sample is generated in the sequence. Also as explained earlier herein, noise 150 is a set of adjustable (i.e. optimizable) numbers (i.e. numeric variables). Each numeric variable in noise 150 is independently adjustable such that each numeric variable provides a respective degree of freedom in noise 150. In other words, each numeric variable provides a respective dimension in noise 150 such that noise 150 evolves within a multidimensional space during optimization, even if all of the numeric variables in noise 150 are stored together in a one-dimensional array. Herein, that multidimensional space is known as a latent space.

Step 501 sets how many numeric variables should noise 150 contain, which in various embodiments is fewer, more, or a same amount of numeric variables as the amount of local samples in a sequence to be generated by generator model 130 for an MLX invocation. For example for storing noise 150, step 501 may set the size of a one-dimensional array to be identical or proportional to the length of the local sample sequence to be generated. The numeric variables in noise 150 may be initialized to respective numbers that step 502 randomly generates. In a preferred embodiment, the noise feature vector is a two-dimensional matrix having a width equal or proportional the amount of features A-B and having a height equal or proportional to a desired or expected amount of local samples in the neighborhood. In that case, the amount of numbers in the noise matrix is linearly proportional to the amount of local samples that will be in the neighborhood. Techniques for generating random numbers are presented in related U.S. patent application Ser. No. 17/124,018.

As explained earlier herein, an MLX invocation may cause multiple models to be trained in sequence. For example first, GAN models 130 and 160 are trained. Second, a random forest may be trained for weighting local samples. Third, surrogate model 180 is trained, possibly based on local sample weights.

Thus, an MLX invocation may have a sequence of those three trainings. Noise optimization and local sample neighborhood sequence generation do not by themselves entail ML model training. For example during the first of those three sequential trainings, step 503 trains generator model 130 without modifying noise 150 that was randomly initialized by step 502.

As explained in related U.S. patent application Ser. No. 17/124,018, noise optimization may entail measuring a (e.g. Euclidian) distance between a local sample and original feature values 120 by step 505, even though similarity measurement between that local sample and original feature values 120 may subsequently be measured based on random forest leaves and without Euclidian distance as explained earlier herein. That is, an embodiment may measure a difference between that local sample and original feature values 120 in two different ways (e.g. Euclidian and non-Euclidian) at two different respective times for two different respective purposes. In other words, difference measurement respectively for noise optimization and for local sample weighting are not a same measurement nor a same way of measuring, even though both measurements regard a difference between a same pair.

Indeed, both measurements are opposites such that noise optimization entails a measure that increases with distance, and local sample weighting entails a measure that instead decreases with distance. In other words, a local sample weight actually measures similarity. As explained in related U.S. patent application Ser. No. 17/124,018, noise optimization may entail: a) calculating a loss based on the distance measured by step 505, and b) adjusting noise 150 by backpropagation without using a neural network in step 506.

### 6.0 Example Training Activities

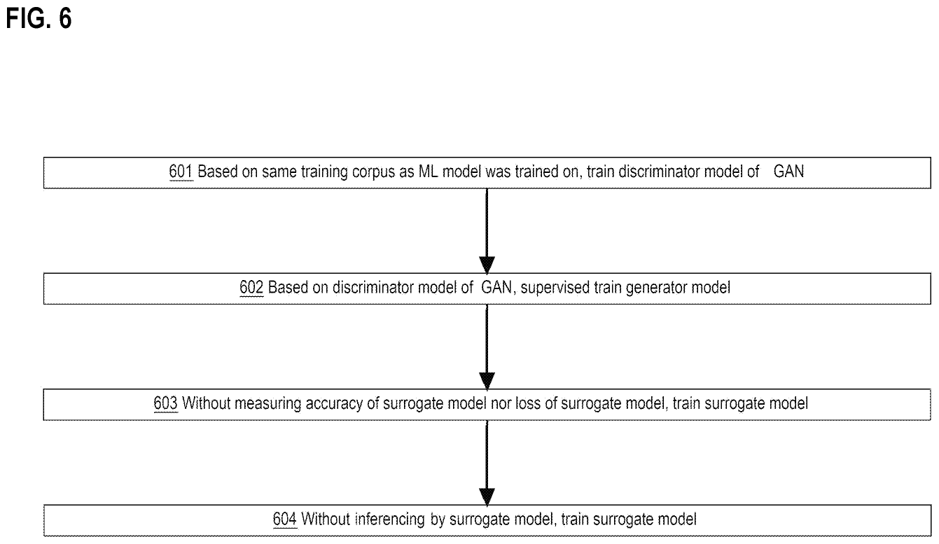

FIG. 6 is a flow diagram that depicts example training activities. FIG. 6 is discussed with reference to FIG. 1.

As explained earlier herein, an embodiment may train various ML models at various respective times. Techniques for training ML models 130 and 160 in GAN 170 are presented in related U.S. patent application Ser. No. 17/124,018. Steps 601-602 entail training in GAN 170 as follows.

Based on same training corpus 140 as ML model 110 was trained on, step 601 trains discriminator model 160 in GAN 170. Based on discriminator model 160 in GAN 170, step 602 supervised trains generator model 130. In an embodiment, training of both GAN models 130 and 160 are supervised because computer 100 knows whether a combination of feature values are natural or whether that combination was instead generated by generator model 130. Likewise, computer 100 knows whether or not discriminator model 160 misclassified that combination as real or fake.

Steps 603-604 entail training surrogate model 180. Because surrogate model 180 is trained only once in an MLX invocation, if an embodiment has both steps 603-604, then steps 603-604 are combined for a same training. Training some ML architectures does not entail feedback such as a gradient such as when surrogate model 180 is a decision tree. For example, without measuring accuracy of surrogate model 180 nor loss of surrogate model 180, step 603 trains surrogate model 180. Likewise, without inferencing by surrogate model 180, step 604 trains surrogate model 180.

### 7.0 Example MLX Activities

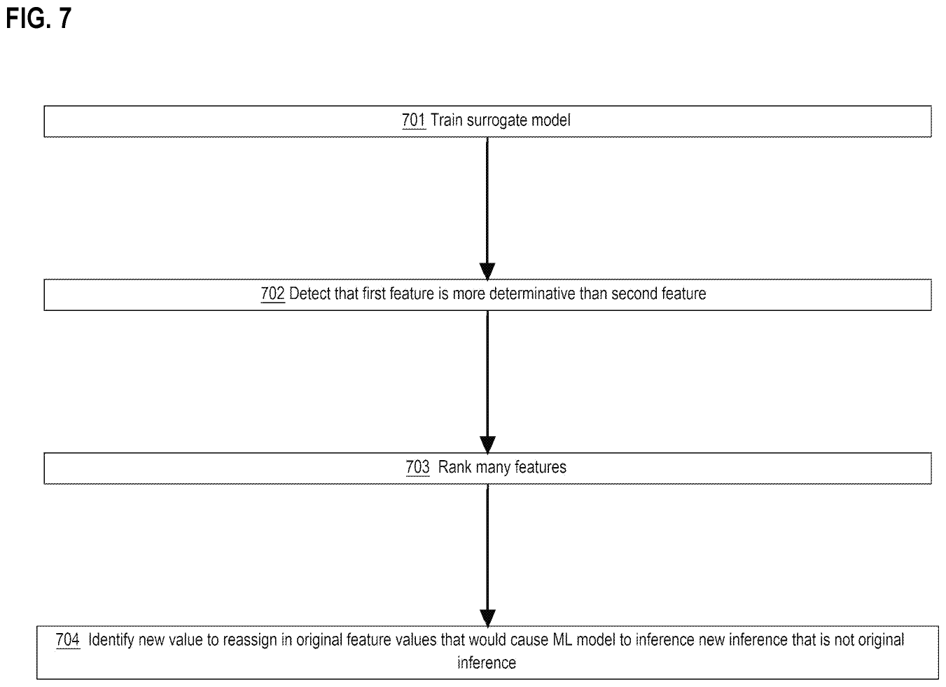

FIG. 7 is a flow diagram that depicts example MLX activities that may occur during an MLX invocation. FIG. 7 is discussed with reference to FIG. 1.

As explained earlier herein, an MLX invocation is a scenario where computer 100 is used to provide an explanation of the behavior of ML model 110 such as regarding original feature values 120 and/or the inferred label for original feature values 120.

As explained earlier herein, an MLX invocation may entail various trainings of various ML models. Various embodiments and scenarios train at least or only surrogate model 180. That is, step 701 trains surrogate model 180 during an MLX invocation.

As explained earlier herein, relative importance of features A-B may facilitate various MLX scenarios such as influencing internal operation while executing the MLX invocation and/or indicating relative feature importance in an explanation as a result of the MLX invocation. Step 702 detects that feature A should be more determinative of inferences that ML model 110 would generate than feature B under some or all conditions. For example, step 702 may detect that inferences that ML model 110 would generate should have a bigger magnitude of correlation to variation in feature A than to feature B based on inspection or operation of surrogate model 180.

As explained earlier herein, local samples may be weighed. In an embodiment, step 702 detects, in the population of generated local samples, which respective statistical variance of features A-B is more positively correlated to variance of local sample weight. Even without weight, if surrogate model 180 is a balanced or optimized decision tree, then step 702 may detect which of features A-B is tested nearer the root of the tree. Techniques of step 702 may be applied to many or all features A-B to establish a relative ordering such as when step 703 ranks features.

As explained earlier herein, speculation may be an important MLX use case such as based on classification boundaries that inspection of surrogate model 180 may reveal. For example, step 704 suggests new value(s) to reassign to feature A and/or B in original feature values 120 that would cause ML model 110 to infer a different inference that was not inferred for original feature values 120.

### 8.0 Generator Model Reusability

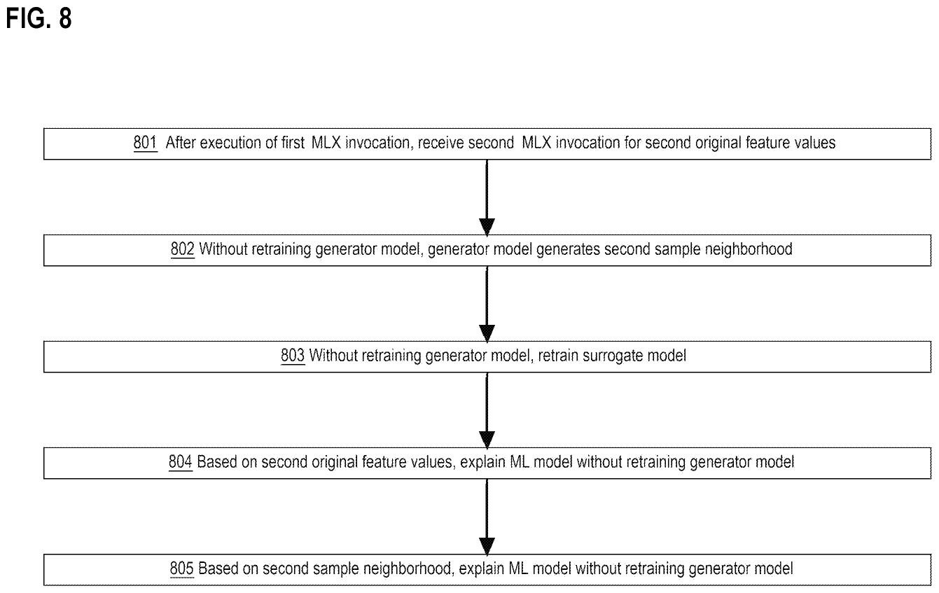

FIG. 8 is a flow diagram that demonstrates reusability of already-trained generator model 130. FIG. 8 is discussed with reference to FIG. 1.

As explained earlier herein, training GAN models 130 and 160 occurs only once, no matter how many MLX invocations follow, so long as training corpus 140 is not revised or replaced. That is, already-trained generator model 130 is reusable such that the cost of training GAN models 130 and 160 may be amortized across many MLX invocations.

Steps 801-805 demonstrate reusability of generator model 130 across two MLX invocations in sequence. For example, if generator model 130 needs training during the first MLX invocation, training generator model 130 is not repeated for the second MLX invocation, even though both MLX invocations have different respective target combinations of original values for features A-B.

After fully executing the first MLX invocation, the second MLX invocation is received for a second combination of original feature values in step 801. Without retraining generator model 130, generator model 130 generates a second local sample neighborhood (i.e. sequence of local samples) in step 802. For example, noise optimization during step 802 is based on the second combination of original feature values.

Without retraining generator model 130, step 803 retrains surrogate model 180, which may entail emptying or replacing surrogate model 180. For example, step 803 may use the second local sample neighborhood. In some embodiments and scenarios, step 803 does not occur, and already-trained surrogate model 180 is reused for the second MLX invocation so long as the first and second combinations of original feature values are identical. For example, the first MLX invocation may ask for a suggestion about changing feature A, and the second MLX invocation may instead regard feature B.

Steps 804-805 contribute to generation of a same explanation and may be combined into a same step. Thus, only one explanation is provided for the MLX invocation. Based on the second combination of original feature values, step 804 explains ML model 110 without retraining generator model 130. Likewise based on the second local sample neighborhood, step 805 explains ML model 110 without retraining generator model 130.

### 9.0 Example Explainer

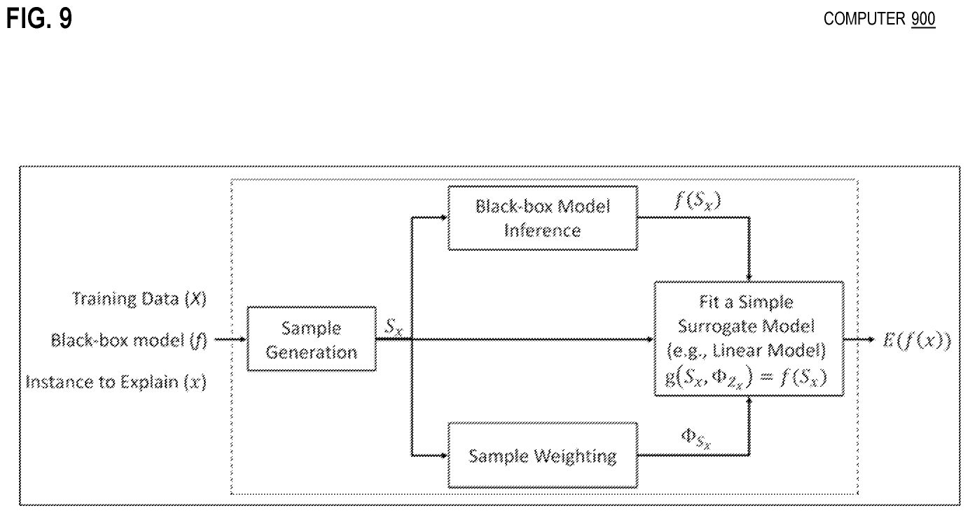

FIG. 9 is a block diagram that depicts example computer 900 that uses a surrogate model to provide optimized explanations of a black-box model. Computer 900 may be an implementation of computer 100.

FIG. 9 also is a dataflow diagram for an MLX invocation such that data flows from left to right according to the arrows. Computer 900 is highly reusable and accepts MLX invocations for different ML models with different training corpuses.

Shown on the left are the following inputs for the MLX invocation.
f is an already-trained black-box classifier model for which an explanation is desired
X is a training corpus that was used to train the classifier model
x is original feature values for which an explanation is desired

Execution of the MLX invocation internally produces and consumes the following intermediate data.
Sₓ is the sequence of local samples generated by a generator model
f(Sₓ) is respective inferences by the classifier model for the generated local samples
φₛ is respective weights of the local samples

The dotted rectangle depicts an explainer subsystem that accepts the inputs, executes the MLX invocation, and outputs an explanation that is shown on the right as E(f(x)). The explainer is reusable such that a subsequent MLX invocation may provide different inputs such as a different classifier model, a different training corpus, and/or different original feature values.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

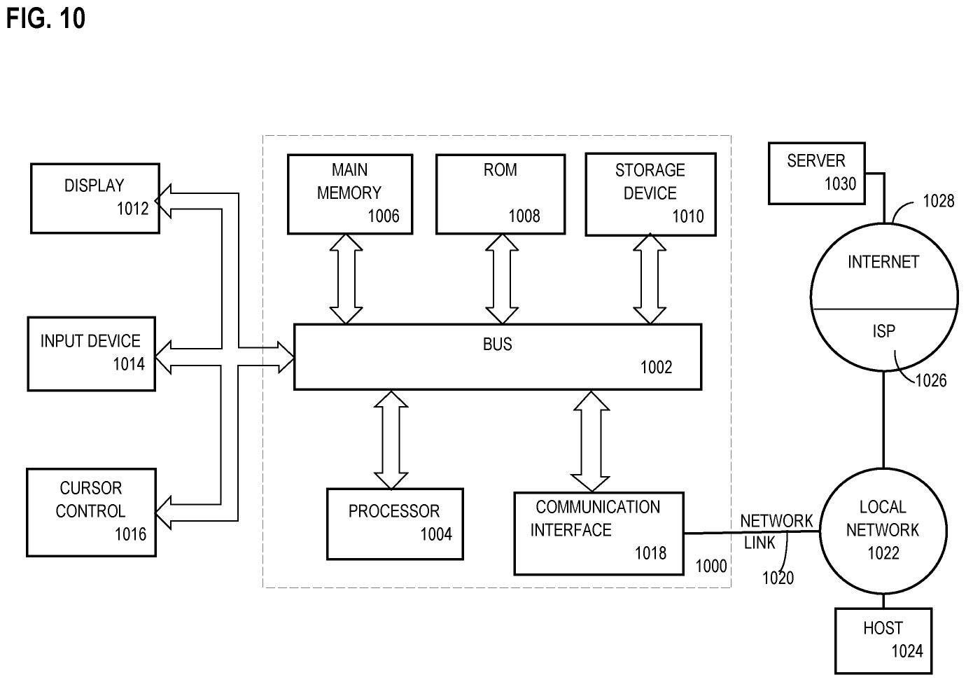

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### Software Overview

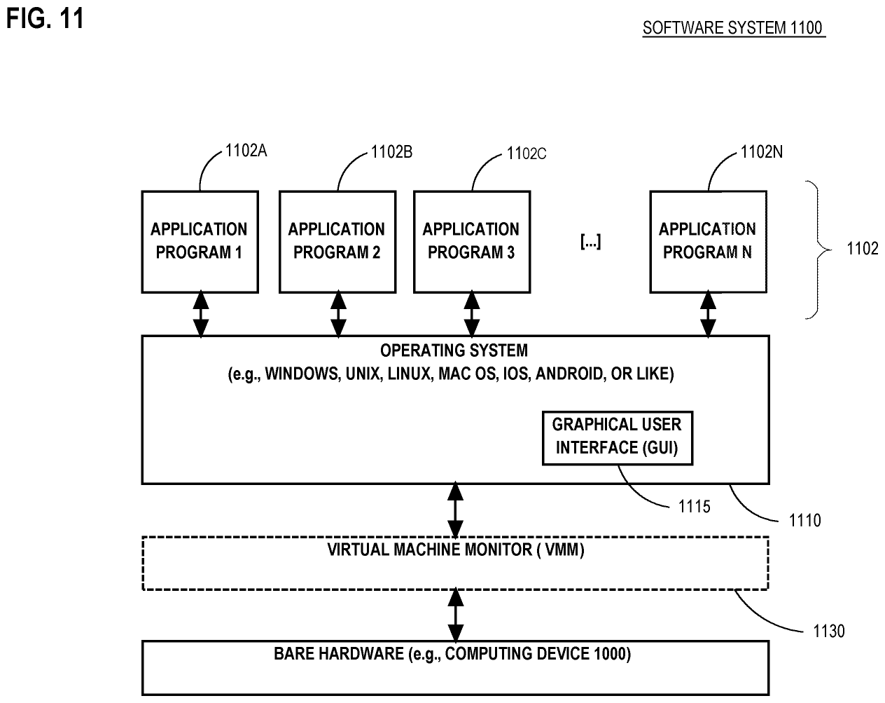

FIG. 11 is a block diagram of a basic software system 1100 that may be employed for controlling the operation of computing system 1000. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computing system 1000. Software system 1100, which may be stored in system memory (RAM) 1006 and on fixed storage (e.g., hard disk or flash memory) 1010, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C . . . 1102N, may be “loaded” (e.g., transferred from fixed storage 1010 into memory 1006) for execution by the system 1100. The applications or other software intended for use on computer system 1000 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by the system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of computer system 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the computer system 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of computer system 1000 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

### Generative Adversarial Network (GAN)

Generative adversarial networks (GANs) are a kind of machine learning algorithm that was originally designed to generate realistic synthetic images but has broader applicability. In an embodiment, a GAN comprises two machine learning models, such as neural networks, acting as two opposing algorithms, a generator and a discriminator. The roles of these neural networks are as follows. The generator tries to generate realistic synthetic data similar to the training data distribution. The generator's training objective is to increase the error rate of the discriminator by producing samples that the discriminator believes are coming from the actual data distribution.

The discriminator tries to distinguish the synthetic data distribution from the true data distribution. The discriminator's training objective is to learn the boundary between authentic (real) and synthetic (fake) data.

In an embodiment, the generator takes as input a random vector, also known herein as a latent random variable, and transforms the random vector into synthetic data similar to the real-world data. The discriminator takes as input the synthetic data generated by the generator and the true data from an input dataset and tries to classify them as real or fake. Although the generator and discriminator train together, the generator can be deployed with or without the discriminator after training.

### GAN Training

In an embodiment, the generator, G, is a differentiable multilayer perceptron with parameters θg that learns to map the input noise variables, z, to the required data space of local samples. This mapping is represented by G(z; θg). In an embodiment, the discriminator, D, is also another multilayer perceptron with parameters θd that learns to output a scalar, D(x; θd), that represents the probability that x came from the true data rather than the synthetic data. During training, D and G effectively play a two-player minimax game in which D tries to maximize the probability of assigning the correct labels to the training data and the synthetic data, and G tries to maximize the probability of the synthetic data being labeled as authentic data. Mathematically, this can be expressed as the following minimax formula.

Min-_{G} max-_{D} V(D, G)=Σ_{x˜X} log(D(x))+Σ_{z˜N(0;1)} log (1−D(G(z)))

With the above minimax formula, D tries to maximize the loss by correctly evaluating the probability that the input sample came from the actual data distribution. Specifically, D tries to maximize D(x) (x represents samples from the true data) and minimize D(G(z)) (G(z) represents the synthetic data). On the other hand, G attempts to minimize the loss function by minimizing the log(1−D(G(z))) or, equivalently, maximizing D(G(z)) (fooling the discriminator, D, to think that the synthetic data samples came from the true data). The components of a GAN are trained simultaneously. The gradient of D guides G to flow to regions of the sample space that are more likely to be classified as true data. In an ideal scenario, after several iterations of training, both D and G reach their optimal state at which they cannot improve anymore. In this case, G has successfully learned the true data distribution and D is unable to distinguish between the two distributions (i.e. outputs D(x)=1/2 for any given sample, regardless of whether the sample came from the true data distribution or the synthetic data distribution).

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
training, based on a plurality of features, a machine learning (ML) model;
inferencing, by the ML model, an original inference for an original plurality of feature values respectively for the plurality of features;
training a generator model to generate pluralities of feature values for same said plurality of features;
training, of a surrogate model, based on the generator model and at least one selected from the group consisting of:
the original inference by the ML model, and
the original plurality of feature values that the original inference is based on;
explaining, based on the surrogate model, the ML model.

2. The method of claim 1 wherein said training the surrogate model is further based on at least one selected from the group consisting of:
a plurality of inferences that are generated by the ML model, and
neighborhood pluralities of feature values that are generated by the generator model after said training the generator model.

3. The method of claim 2 wherein said training the surrogate model comprises assigning a respective weight to each plurality of feature values of the neighborhood pluralities of feature values.

4. The method of claim 3 wherein said assigning said weight comprises measuring a similarity between said plurality of feature values and said original plurality of feature values.

5. The method of claim 4 wherein said measuring said similarity comprises identifying leaves of a plurality of decision trees that contain both of said plurality of feature values and said original plurality of feature values.

6. The method of claim 5 wherein said measuring said similarity further comprises counting the neighborhood pluralities of feature values that respectively occur in each leaf of said leaves of the plurality of decision trees that contain said both of said plurality of feature values and said original plurality of feature values.

7. The method of claim 5 wherein the surrogate model does not comprise said plurality of decision trees.

8. The method of claim 3 wherein said assigning said weight comprises none of: a Euclidian distance and a Mahalonobis distance.

9. The method of claim 1 further comprising generating a plurality of random numbers to be used by said training the generator model.

10. The method of claim 9 further comprising optimizing the plurality of random numbers is based on at least one selected from the group consisting of:
backpropagation without using a neural network, and
a distance between the original plurality of feature values that the original inference is based on and a current plurality of feature values of the neighborhood pluralities of feature values that the generator model generated.

11. The method of claim 9 further comprising the generator model generating an amount of neighborhood pluralities of feature values that is linearly proportional to the amount of said plurality of random numbers.

12. The method of claim 9 wherein said training the generator model does not comprises modifying said plurality of random numbers.

13. The method of claim 1 wherein said explaining based on the surrogate model comprises at least one selected from the group consisting of:
detecting that a first feature of said plurality of features is more determinative than a second feature of said plurality of features,
ranking said plurality of features,
identifying a new value to reassign in the original plurality of feature values that would cause the ML model to inference a new inference that is not the original inference, and
said training said surrogate model.

14. The method of claim 1 wherein said training the surrogate model comprises none of:
inferencing by the surrogate model, and
measuring at least one selected from the group consisting of: accuracy of the surrogate model, and loss of the surrogate model.

15. The method of claim 1 wherein said training the generator model comprises supervised training based on a discriminator model of a generative adversarial network (GAN).

16. The method of claim 15 wherein said training the generator model comprises training the discriminator model of the GAN based on a same training corpus as the ML model was trained on.

17. The method of claim 1 further comprising for a second original plurality of feature values that the generator model did not generate, without retraining the generator model performing at least one selected from the group consisting of:
the generator model generating neighborhood pluralities of feature values, retraining the surrogate model, and
explaining the ML model based on at least one selected from the group consisting of:
the second original plurality of feature values, and
the neighborhood pluralities of feature values.

18. One or more computer-readable non-transitory media storing instructions that, when executed by one or more processors, cause:
training, based on a plurality of features, a machine learning (ML) model;
inferencing, by the ML model, an original inference for an original plurality of feature values respectively for the plurality of features;
training a generator model to generate pluralities of feature values for same said plurality of features;
training, of a surrogate model, based on the generator model and at least one selected from the group consisting of:
the original inference by the ML model, and
the original plurality of feature values that the original inference is based on;
explaining, based on the surrogate model, the ML model.

19. The one or more computer-readable non-transitory media of claim 18 wherein said training the surrogate model is further based on at least one selected from the group consisting of:
a plurality of inferences that are generated by the ML model, and
neighborhood pluralities of feature values that are generated by the generator model after said training the generator model.

20. The one or more computer-readable non-transitory media of claim 18 wherein the instructions further cause generating a plurality of random numbers to be used by said training the generator model.
